(19) United States
(12) Patent Application Publication
(10) Pub. No.: US 2001/0025545 A1
(43) Pub. Date: Oct. 4, 2001

(54) Handwheel for a nursery gate frame adjustment mechanism

(76) Inventor: John Rogers, Stafford (GB)

Correspondence Address: BARNES & THORNBURG, 11 South Meridian Street, Indianapolis, IN, 46204, US

(21) Appl. No.: 09/726,110

(22) Filed: Nov. 29, 2000

(30) Foreign Application Priority Data
Nov. 29, 1999 (GB) UK9928070.3

(51) Int. Cl. B62D 1/04; G05G 1/10

(52) U.S. Cl. 74/552; 74/553

(57) ABSTRACT

A hand wheel 10 for a nursery gate frame adjustment mechanism comprises a ratchet member 12 received in a housing. The ratchet member 12 has respective ratchet surfaces 24, 26 on opposite faces thereof, A screw-threaded bore 22 is formed through the ratchet member 12. The housing has a first part 14 for co-operating with the ratchet surface 24 on one face of the ratchet member 12 and a second part 16 for co-operating with the opposite ratchet surface 26 on the other face of the ratchet member 12. A compression spring 18 biases the ratchet member 12 towards the first part of the housing. In that way the hand wheel 10 rotates the ratchet member 12 in one direction by engagement of the first part 14 with the ratchet surface 24. In order to rotate the ratchet member in the opposite direction, the housing and ratchet member must be moved relative to each other against the bias of the spring 18 so that the second part 16 of the housing engages the ratchet surface 26.

The invention relates to a hand wheel for a nursery gate frame adjustment mechanism and particularly to but not exclusively limited to a hand wheel for an frame adjustment mechanism which enables the frame of the nursery gate to be secured within an opening by screwing a pad out from the frame of the nursery gate against the edge of the opening in which the nursery gate is to be secured.

Nursery gates are well known and generally comprise a frame which is secured in an opening, the frame having a door hinged thereto which allows adults to pass through the opening but which can be secured to prevent infants from passing through the opening. The frame is generally secured within the opening by means of four pads which frictionally engage, for example a door frame. Each pad has a screw threaded rod which is slideably located in the frame and a hand wheel is arranged on the screw threaded rod. By screwing the hand wheel along the screw threaded rod the distance between the hand wheel and the pad on the end of the rod is varied and the hand wheel abuts the frame of the nursery gate so that the pad can be screwed outwardly until the frame is held in compression by the four pads, two each side of the frame, top and bottom. Such a mechanism is described as a “frame adjustment mechanism” herein. The frame must be secured tightly within the opening to prevent an infant from forcing the gate out of the opening. Older infants and children can tamper with the hand wheel to loosen the fit of the nursery gate frame within the opening.

It is an object of the present invent to provide an improved form of hand wheel for a nursery gate frame adjustment mechanism.

In accordance with the invention there is provided a hand wheel for a nursery gate fame adjustment mechanism comprising a ratchet member having respective ratchet surfaces on opposite faces thereof and a screw threaded bore formed therethrough, a housing comprising a first part for co-operating with the ratchet surface on one face of the ratchet member and a second part for co-operating with the ratchet surface on the other face of the ratchet member and biasing means for biasing the ratchet member towards the first part of the housing whereby the hand wheel rotates the ratchet member in one direction and in order to rotate the ratchet member in the opposite direction the housing and ratchet member must be moved against the bias so that the ratchet member engages the second part of the housing.

In that way, the hand wheel can be arranged so that rotation in the direction of tightening of the adjustment mechanism is only possible without moving the housing of the hand wheel against the biasing means. Thus if a child attempts to tamper with the hand wheel the only effect will be further to tighten the frame within the opening. When the frame is required to be removed from the opening the housing can be moved against the bias so that the second part of the housing engages the ratchet surface on the other face of the ratchet member and rotation of the ratchet member is possible in the “loosening” direction.

The housing preferably receives the ratchet member therewithin. The ratchet member is preferably disc-like. In such a case the ratchet surfaces preferably comprise ratchet teeth arrange so as to enable driving of the ratchet member in one direction on one side and in the other direction on the other side of the disc-like member. A screw threaded bore is preferably formed centrally thereof

The first part of the housing preferably comprises a cup-like member having an aperture formed therethrough to allow passage of the screw threaded rod of the nursery gate frame adjustment mechanism, the cup-like member further comprising a substantially circular base and the circular peripheral wall, the first part having a ratchet co-operating formation on the inner surface of the base. The ratchet co-operating formation is arranged to cooperate with the ratchet surface of the ratchet member to drive the ratchet member in the tightening direction. The peripheral wall is preferably provided with gripping formations therein to facilitate gripping of the hand wheel by the user. The second part of the housing is identical to the first part and is arranged mouth to mouth with the cup-like first part. The ratchet co-operating formation thus co-operates with the other ratchet surface of the ratchet member to drive it in the loosening direction.

The biasing means preferably comprises a compression spring arranged between the ratchet member and the second part pushing the ratchet member away from the second part into engagement with the first part. In order to rotate the ratchet member in the “loosening” direction the housing must be moved against the bias of the compression spring so that the ratchet engaging formation on the inner surface of the base of the second part of the housing engages with ratchet surface on the other side of the ratchet member.

The embodiment of the invention will now be described in detail by way of example and with reference to the accompanying drawing in which:

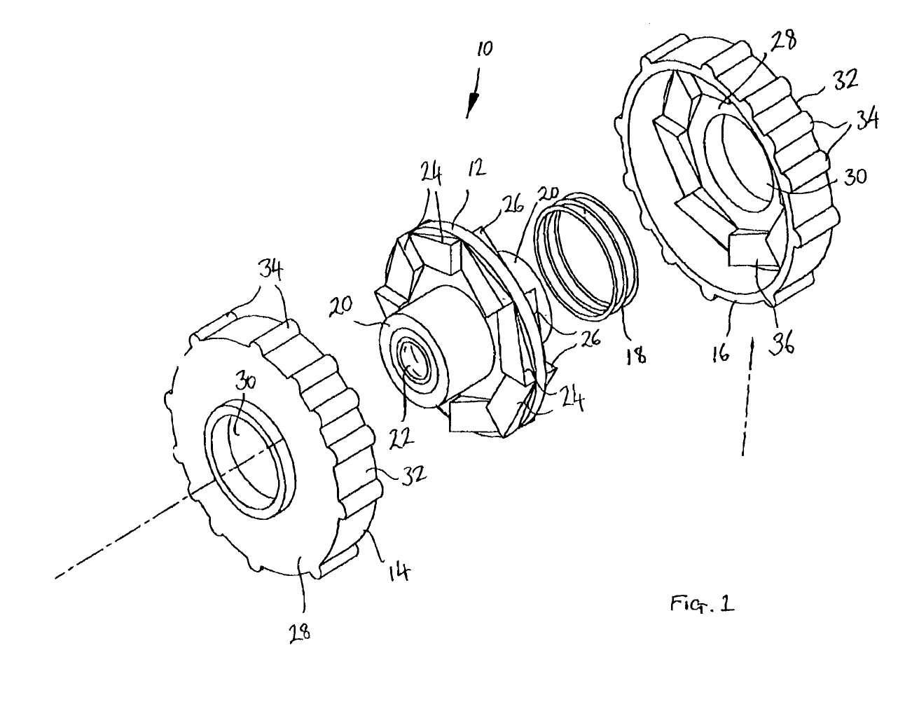

FIG. 1 is an exploded perspective view of a hand wheel in accordance with the invention.

In FIG. 1 the hand wheel assembly 10 comprises a ratchet member 12, a housing having first and second parts respectively 14, 16 and spring arranged between the ratchet member 12 and the second part 16 of the housing.

The ratchet member 12 comprises a substantially disc-like body have a central hub 20 extending from each face thereof. A screw threaded bore 22 is formed through the central hub 20 co-axially of the disc. On the face of the ratchet member 12 arranged towards the first housing part 14 there is a series of ratchet teeth 24 arranged adjacent the edge of the disc so that a space is defined between the hub 20 and the teeth 24. The teeth 24 are arranged so as to allow rotation of the ratchet member in the anticlockwise direction as viewed in FIG. 1.

On the opposite face of the ratchet member ratchet teeth 26 are also arranged around the disc member adjacent the edge thereof. However, the ratchet teeth are arranged on that face so as to permit clockwise rotation of the ratchet member as viewed in FIG. 1.

The first housing part 14 comprises a substantially circular base 28 having an aperture 30 formed therein generally centrally thereof, which is arranged to receive the central hub 20 of the ratchet member 12. A peripheral wall 32 extends from the circular base 28. The peripheral wall 32 is provided with gripping formations 34 which comprise small projections spaced apart about the peripheral wall 32. On the inside of the circular base 28 which faces the ratchet member 12 a ratchet co-operation surface (not shown) is provided which is intended to co-operate in a driving manner with the ratchet teeth 24 on the ratchet member 12 so as to enable driving of the ratchet member in the anti-clockwise direction as mentioned above.

The second housing part is substantially similar to the first housing part comprising a substantially circular base 28 having a central aperture 30 formed therein with a circular peripheral wall 32 having gripping formation 34 formed thereon extending from the circular base 28. The ratchet co-operation surface 30 fixed to the second part 16 is visible in FIG. 1 and it can be seen that the co-operation of the ratchet co-operation surface 36 of the ratchet teeth 26 on the ratchet member would tend to drive the ratchet member in the clockwise direction as viewed in FIG. 1. The compression spring I8 is dimensioned so that it fits around central hub 20 and that it will fit in the space between the hub 20 and the ratchet teeth 26 on the ratchet member 12. The other end of the spring 18 abuts the inner surface of the circular base 28 of the second housing part 16. The first and second housing parts 14, 16 are fixed together, for example by welding and/or gluing. When the hand wheel is assembled the spring 18 tends to push the ratchet member 12 against the first part of the housing 14 so that the ratchet co-operation surface on the first housing part 14 cooperates with the teeth 24 on the appropriate face of the ratchet member so that anti-clockwise rotation of the ratchet member is possible while clockwise rotation of the ratchet member is prevented. In order to effect clockwise rotation of the ratchet member the housing is urged against the spring bias so that the second housing part 16 moves against the ratchet member 12. In that way, the ratchet co-operation surface 36 comes into engagement with the ratchet teeth 26 which are arranged to enable driving of the ratchet member in a clockwise direction.

When arranged appropriately on a nursery gate frame adjustment mechanism the hand wheel described above will in its normal state only allow further tightening of the frame and movement of the housing relative to the ratchet against the spring bias is required to effect loosening of the frame in the opening.

In that way an anti-tamper adjustment mechanisms is provided in which children are restricted from inadvertently, or deliberately loosening the gate from the opening.

1. A hand wheel for a nursery gate frame adjustment mechanism comprising a ratchet member having respective ratchet surfaces on opposite faces thereof arranged to drive the member in opposite rotational directions and a screw threaded bore formed therethrough, a housing comprising a first part for co-operating with the ratchet surface on one face of the ratchet member and a second part for co-operating with the ratchet surface on the other face of the ratchet member and biasing means for biasing the ratchet member towards the first part of the housing whereby the hand wheel rotates the ratchet member in one direction and in order to rotate the ratchet member in the opposite direction the housing and ratchet member must be moved against the bias so that the ratchet member engages the second part of the housing.

2. A hand wheel according to claim 1 in which the housing receives the ratchet member therewithin.

3. A hand wheel according to claim 1 in which the ratchet member is disc-like.

4. A hand wheel according to claim 2 in which the ratchet member is disc-like.

5. A hand wheel according to claim 3 in which the ratchet surfaces comprise ratchet teeth arranged so as to enable driving of the ratchet member in one direction on one side and in the other direction on the other of the disc-like member.

6. A hand wheel according to claim 4 in which the ratchet surfaces comprise ratchet teeth arranged so as to enable driving of the ratchet member in one direction on one side and in the other direction on the other of the disc-like member.

7. A hand wheel according to claims 3, 4, 5 or 6 in which a screw threaded bore is formed centrally of the disc-like member.

8. A hand wheel according to claim 1 in which the first part of the housing comprises a cup-like member having an aperture formed therethrough to allow passage of the screw threaded rod of the nursery gate adjustment mechanism, the cup-like member further comprising a substantially circular base and the circular peripheral wall, the first part having a ratchet co-operating formation on the inner surface of the base.

9. A hand wheel according to claim 8 in which the ratchet co-operating formation is arranged to cooperate with the ratchet surface of the ratchet member to drive the ratchet member in the tightening direction.

10. A hand wheel according to claim 8 in which the peripheral wall is provided with gripping formations therein to facilitate gripping of the hand wheel by the user.

11. A hand wheel according to claim 9 in which the peripheral wall is provided with gripping formations therein to facilitate gripping of the hand wheel by the user.

12. A hand wheel according to claim 8 in which the second part of the housing is identical to the first part and is arranged mouth to mouth with the cup-like first part.

13. A hand wheel according to claim 8 in which the ratchet co-operating formation on the second part cooperates with the other ratchet surface of the ratchet member to drive it in the loosening direction.

14. A hand wheel according to claim 1 in which the biasing means comprises a compression spring arranged between the ratchet member and the second part pushing the ratchet member away from the second part into engagement with the first part.

15. A nursery gate frame adjustment mechanism having a hand wheel comprising a ratchet member having respective ratchet surfaces on opposite faces thereof arranged to drive the member in opposite rotational directions and a screw threaded bore formed therethrough, a housing comprising a first part for co-operating with the ratchet surface on one face of the ratchet member and a second part for co-operating with the ratchet surface on the other face of the ratchet member and biasing means for biasing the ratchet member towards the first part of the housing whereby the hand wheel rotates the ratchet member in one direction and in order to rotate the ratchet member in the opposite direction the housing and ratchet member must be moved against the bias so that the ratchet member engages the second part of the housing.

16. A nursery gate comprising a frame adjustment mechanism having a handwheel comprising a ratchet member having respective ratchet surfaces on opposite faces thereof arranged to drive the member in opposite rotational directions and a screw threaded bore formed therethrough, a housing comprising a first part for co-operating with the ratchet surface on one face of the ratchet member and a second part for co-operating with the ratchet surface on the other face of the ratchet member and biasing means for biasing the ratchet member towards the first part of the housing whereby the hand wheel rotates the ratchet member in one direction and in order to rotate the ratchet member in the opposite direction the housing and ratchet member must be moved against the bias so that the ratchet member engages the second part of the housing.
